(19) United States
(12) Patent Application Publication
(10) Pub. No.: US 2018/0214914 A1
(43) Pub. Date: Aug. 2, 2018

(54) IN-LINE PROCESS

(71) Applicant: Dow Global Technologies LLC, Midland, MI (US)

(72) Inventors: Kevin J. Meyer, Houston, TX (US); Douglas L. Potts, Clute, TX (US); Thomas P. Willumstad, Pearland, TX (US); Avery L. Watkins, Pearland, TX (US)

(21) Appl. No.: 15/747,829

(22) PCT Filed: Jul. 18, 2016
(86) PCT No.: PCT/US2016/042812

§ 371 Date: Jan. 26, 2018

Related U.S. Application Data
(60) Provisional application No. 62/198,913, filed on Jul. 30, 2015.

(51) Int. Cl. B08B 3/04; C08J 5/08; B29B 15/12; B29B 15/14; B29C 53/56; B29C 53/84; B08B 3/10; B08B 5/00

(52) U.S. Cl. CPC B08B 3/041; C08J 5/08; B29B 15/125; B29B 15/14; B29B 2013/002; B29C 53/845; B08B 3/10; B08B 5/00; C08J 2375/08; B29C 53/56

(57) ABSTRACT

A process for removing contaminants from a fiber reinforcement material, the process comprising: (a) feeding a fiber reinforcement into a heated vessel, (b) passing the fiber reinforcement through the heated vessel, (c) heating a source of fluid medium, (d) feeding the heated fluid medium from (c) into the heated vessel having a passageway in the heated vessel for allowing the heated fluid medium from (c) to enter into the heated vessel, (e) passing the heated fluid medium through the heated vessel; wherein the heated vessel has a passageway for allowing the heated fluid medium from (c) to exit the heated vessel, and (f) contacting the fiber reinforcement passing through the heated vessel with the heated fluid medium passing through the heated vessel such that any contaminants present in or on the fiber reinforcement is sufficiently reduced to provide a purified fiber reinforcement exiting the heated vessel.

### FIELD

The present invention is related to an in-line process for manufacturing a composite structure; and more specifically to an in-line process for manufacturing a composite structure including a pre-treatment step for contaminant removal such as for example a pre-treatment step for removing moisture and/or solvent.

### INTRODUCTION

Heretofore, various methods and pipe structures have been used for removing contaminants from the fluids flowing through the pipe structures. Typically, the known methods for removing contaminants are based on coatings applied to pipe substrates which traditionally include steel, aluminum, and the like. For example, U.S. Pat. Nos. 8,726,989 and 8,746,335 disclose a method for removing contaminants from wastewater in a hydraulic fracturing process. The above patents discuss removal of contaminants during a hydraulic fracturing process utilizing a pipe coating for traditional metal piping applications (e.g., steel, aluminum, and the like). The above known processes disclosed in U.S. Pat. Nos. 8,726,989 and 8,746,335 suffer from the disadvantage of utilizing a coating on the inner surface of a pipe to capture contaminants from hydraulic fracturing operations. The use of a coating is disadvantageous because an extra layer is required for the overall structure of the pipe, it limits the inner diameter of the pipe; and an additional processing step is required for the coating layer when manufacturing the pipe. The process of the above prior art does not provide for a contaminant removal mechanism which is incorporated directly into the pipe structure which can reduce the time of part fabrication.

U.S. Pat. No. 4,171,238 discloses a method of making reinforced plastic composite structures. The above patent describes the incorporation of micron-size particulate, such as cement particles, for the purpose of reducing the amount of wear that occurs inside of a pipe. Additionally, the above patent disclosure is concerned with increasing resistance to acids or other corrosive materials. The patent further discloses an attempt to make a particulate and resin bonded together in a single matrix wherein the particulate is suspended inside the resin such as a polyester resin. The above known process disclosed in U.S. Pat. No. 4,171,238 suffers from the disadvantage of requiring the distribution of particles throughout all fiber reinforced regions and not being able to preferentially place the particles in predetermined fiber reinforced regions of the fiber reinforced composite to maximize functionalization while minimizing cost.

In U.S. Pat. No. 6,620,475, a structure for a wound fiber reinforced plastic tubing and method for making the tubing is described. The above patent describes the formation and manufacture of a fiber-reinforced composite pipe through a filament winding process using an inner liner and one or more layers of fiber reinforcing material. The above known process disclosed in U.S. Pat. No. 6,620,475 does not utilize the inner liner of the composite material as a multifunctional material that is able to capture unwanted contaminants from a flowing fluid coming in direct contact with the composite surface.

U.S. Patent Application Publication No. 2005/0038222A1 discloses a filament winding process for making a composite article. The filament winding process is based on mixing initiated polymerization of an at least two-component resin system, the system comprising an organic polyisocyanate and a polyfunctional active hydrogen composition as the principle isocyanate reactive species. US2005/0038222A1 further provides improved composite articles produced by the filament winding process. However, US2005/0038222A1 is directed to a specific composition for a polyurethane-based filament winding thermosetting liquid and does not teach the quality of the resulting laminate structure produced through filament winding. For example, US2005/0038222A1 does not disclose any process for producing a void-free composite structure.

With reference to FIG. 1, there is shown a filament winding apparatus of the prior art, generally indicated by numeral 100. The filament winding apparatus 100 includes a fiber reinforcement feeding apparatus, generally indicated by numeral 10 which may include stored continuous creels 11 of fibers 12 for dispensing the several continuous fibers 12 to the process. The fibers 12 are consolidated and passed through guide bars 13 for filament alignment and forming consolidated fiber reinforcement 21. The consolidated fiber reinforcement 21 contains contaminants. The consolidated fiber reinforcement 21 with contaminant is fed to a resin coating means, generally indicated by numeral 30, which includes an open bath 32 containing a thermosetting liquid 33 therein. The consolidated fiber reinforcement 21 is fed to, submersed in, and passed through the thermosetting liquid 33 in the open bath 32. The open bath 32 also includes fiber guides 34 for fiber control through wet out. The consolidated fiber reinforcement 41 containing uncured or partially cured thermosetting liquid thereon are pulled from the open bath 32 onto a rotating mandrel 51 to form a composite article, for example a pipe member. Then the pipe member is cured with a post-winding curing means (not shown). Once cured, the pipe member product coming off the mandrel 51 can be cut to a desired length.

With reference to FIG. 2, there is shown a micrograph image (at 10× magnification) of the fiber reinforcement 41 which shows voids 42 caused by bubbling foaming; glass fiber 43; and Zeolite water scavenger 44. As shown in FIG. 2, a fiber reinforcement material that is not treated to remove contaminants such as moisture, the resulting cured fiber-reinforced composite article will contain undesirable voids which can act as stress concentrators during the mechanical loading of the composite structure.

### SUMMARY

The present invention is directed to a pretreatment process and a pretreatment apparatus or device for removing contaminants from a fiber reinforcement material prior to the fiber reinforcement material being processed in a process for manufacturing a fiber-reinforced composite article. In one embodiment, for example, the pretreatment device includes:

(a) a vessel such as a closed box having housing or open container/bath;

(b) an entry means disposed in the housing adapted for feeding a contaminated fiber reinforcement material into the interior of the housing of (a), the fiber reinforcement containing an initial level of contaminants of greater than greater than about 250 parts per million (ppm);

(c) a means for feeding the contaminated fiber reinforcement material through, and into, the housing of (a) via the entry means of (b);

(d) a passageway from the entry means of (b) into the housing adapted for allowing the contaminated fiber from (b) to enter into the housing of (a);

(e) an entry means disposed in the housing adapted for feeding a heated fluid medium into the interior of the housing of (a);

(f) a means for feeding the heated fluid medium into and through the housing of (a) via the entry means of (e);

(g) a passageway from the heated fluid medium entry means of (e) into the housing adapted for allowing the heated fluid medium from (f) to enter into the housing of (a) and allowing the heated fluid medium to contact the contaminated fibers inside the housing;

(h) an exit means disposed in the housing adapted for discharging the heated fluid medium from the housing of (a);

(i) a passageway from the inside of the housing (a) to the outside of the housing adapted for allowing the heated fluid medium from (h) to exit the housing of (a);

(j) an exit means disposed in the housing adapted for discharging a purified fiber reinforcement material, after being contacted with the heated fluid medium, from the housing of (a); and

(k) a passageway from the inside of the housing (a) to the outside of the housing adapted for allowing the purified fiber from (j) to exit the housing of (a).

In another embodiment, for example, the pretreatment process for removing contaminants from a contaminated fiber reinforcement material using the above pretreatment device includes:

(i) feeding a contaminated fiber reinforcement material into a pretreatment device, the fiber reinforcement containing an initial level of contaminants of greater than about 250 ppm;

(ii) passing the contaminated fiber reinforcement material through the inside of the pretreatment device;

(iii) feeding a heated fluid medium into the pretreatment device such that the heated fluid medium contacts the contaminated fibers passing through the inside the pretreatment device and such that the heated fluid medium captures contaminants present on the contaminated fibers;

(iv) discharging the heated fluid medium containing captured contaminants of step (iii) from the pretreatment device;

(v) discharging a purified fiber reinforcement material from the pretreatment device; wherein the purified fiber reinforcement material is the resultant fibers after being contacted with the heated fluid medium in step (iii); and wherein the purified fiber reinforcement material contains a level of contaminants less than the initial level of contaminants on the original contaminated fiber reinforcement material; and

(vi) passing the purified fiber reinforcement material from the inside of the pretreatment device to the outside of the pretreatment device and allowing the purified fiber to exit the pretreatment device to be further processed or collected.

In another embodiment, for example, when the purified fiber reinforcement material exits from the pretreatment device, the purified fiber reinforcement material can be further processed and used to manufacture a fiber-reinforced composite article such as a laminate.

Still other embodiments of the present invention includes a filament winding apparatus and process for manufacturing a cured fiber reinforced composite article using the above pre-treatment device for removing contaminants from a contaminated fiber reinforcement material.

One preferred embodiment of the present invention is directed to a process of manufacturing a fiber-reinforced composite article; and more specifically, to a process for preparing a fiber-reinforced composite material utilizing a contaminant removal step in an in-line manufacturing process.

Another preferred embodiment of the present invention is directed to a novel in-line contaminant removal process whereby contaminated stored continuous fiber reinforcement is drawn through a contaminant removal step (a pretreatment step), reducing the amount of contaminant present on the fiber reinforcement. The contaminants may include for example contaminants such as water, solvents, or other contaminants capable of being removed through convective heat transfer. The contaminants are reduced to below a level that will not cause defects within the fiber-reinforced composite article which can be for example a fiber reinforced laminate structure.

The present invention includes the use of a filament winding process in combination with the contaminant removal process of the present invention to manufacture a fiber reinforced composite article. However, the scope of the composite structure fabrication process of the present invention is not limited to only a filament winding process but can include any fiber reinforced composite fabrication method such as a pultrusion method, a resin transfer molding method, or a combination of pultrusion and resin transfer molding methods.

For example, another preferred embodiment of the present invention includes a process of manufacturing a void-free composite article comprising the steps of:

(a) providing a continuous fiber reinforcement;

(b) providing an in-line device for removing contaminants from the continuous fiber reinforcement;

(c) pre-treating the continuous fiber reinforcement by passing the fiber reinforcement through the -line contaminant removal device of (b) and heating the continuous fiber reinforcement within the contaminant removal device;

(d) contacting the pretreated continuous fiber reinforcement from the pre-treatment step (c) with a thermosetting polymer resin by passing the pretreated fiber reinforcement through an open-bath of a resin formulation containing a thermosetting polymer resin or via a resin injection means for impregnating a resin formulation containing a thermosetting polymer resin into the pretreated continuous fiber reinforcement;

(e) passing the pretreated continuous fiber reinforcement from the contaminant removal device of (b) through the open-bath or the injection means of (d);

(f) providing a filament winding manufacturing apparatus;

(g) passing the pretreated continuous fiber reinforcement from the open-bath through a filament winding manufacturing apparatus to form a fiber reinforced composite article; and

(h) heating the fiber reinforced composite structure from the filament winding apparatus to form a void-free fiber reinforced composite article.

Still another embodiment of the present invention is directed to a fiber-reinforced composite article manufactured using the above process.

### BRIEF DESCRIPTION OF THE DRAWINGS

For the purpose of illustrating the present invention, the drawings show a form of the present invention which is presently preferred. However, it should be understood that the present invention is not limited to the precise arrangements and instrumentation shown in the drawings. In the drawings, like elements are referenced with like numerals. Therefore, the following drawings illustrate non-limiting embodiments of the present invention wherein:

FIG. 1 is a schematic flow diagram showing a conventional filament winding process of the prior art for forming a composite article including an open bath containing thermosetting liquid, and a rotating mandrel of a filament winding apparatus.

FIG. 2 is a micrograph image (at 10× magnification) of a cross-sectional view of a composite structure made with polyurethane based-chemistry and the conventional filament winding process of FIG. 1. FIG. 2 shows the composite with air formation in the composite structure and voids caused by bubbling and foaming In this case, the bubbling and/or foaming are caused by the isocyanate reaction with moisture present on the fiber surface.

FIG. 3 is a schematic flow diagram showing a filament winding process of the present invention including a pretreatment device of the present invention. FIG. 3 shows the pretreatment device as an in-line heating unit with a single consolidated fiber bundle passing therethrough.

FIG. 4 is a micrograph image (at 10× magnification) of a cross-sectional view of a composite structure made with polyurethane based-chemistry and the filament winding process of FIG. 3. FIG. 4 shows the composite with no air formation in the composite structure. The small particles shown in the image of FIG. 4 are water scavengers that do not detrimentally affect the performance of the composite.

FIG. 5 is a partial schematic flow diagram showing the front end of another filament winding process implementing an in-line contaminant removal pretreatment device. FIG. 2 shows the pretreatment device as an in-line heating unit with multiple fiber tows passing therethrough.

FIG. 6 is a schematic flow diagram showing still another embodiment of a filament winding process of the present invention including a pretreatment device of the present invention. The schematic flow diagram of FIG. 6 shows an alternative pretreatment device of the present invention comprising an open bath containing a contaminant-philic liquid for removing contaminants on the surface of a fiber bundle passing therethrough, an open bath containing thermosetting liquid, and a rotating mandrel of a filament winding apparatus for forming a composite article.

FIG. 7 is a schematic flow diagram showing another embodiment of a filament winding process of the present invention including a pretreatment device of the present invention. In addition to the pretreatment device as an in-line heating unit with a single consolidated fiber bundle passing therethrough, the schematic flow diagram of FIG. 7 shows an open bath containing thermosetting liquid, a curing die, a pulling apparatus, and a cutting apparatus for cutting the cured fiber reinforcement composite article.

### DETAILED DESCRIPTION

“Void space” herein, with reference to a cured composite article, means a resulting empty space or air pocket embedded in a composite structure resulting from bubble formation within the composite structure during curing of a thermosetting polymer to form the composite structure.

“Void-free” herein, with reference to a composite article, means that the article has no unwanted or undesired void spaces embedded in a composite structure resulting formed during curing of a thermosetting polymer to form the composite structure.

“Thermosetting system” herein means a composition comprising two or more components that can undergo a chemical reaction to form a chemically cross-linked network.

“Contaminated fiber” herein means a fiber that has an unwanted or undesired liquid material contaminant on the surface of the fiber; or at least contains more than about 250 ppm of unwanted or undesired liquid material contaminant on the surface of the fiber.

“Uncontaminated fiber” or “purified fiber” herein (and in the claims) means a fiber that has no unwanted or undesired liquid material contaminant on the surface of the fiber or at least contains less than about 250 ppm unwanted or undesired liquid material contaminant on the surface of the fiber. For example, the undesired liquid material may be water.

“Impregnating”, “impregnate” or impregnated” herein, with reference to a fiber bundle, means the act of a thermosetting liquid penetrating the fiber bundle and forming a homogenous resin/fiber structure.

“Wet-out” or “wetted-out” with reference to a fiber bundle, is a qualitative or quantitative measure of the degree of penetration of the thermosetting liquid into the bundle and forming a homogenous resin/fiber structure.

“Contaminant-philic liquid” herein means a liquid with sufficient affinity for the contaminant liquid on the fibers that, when a fiber is drawn through the contaminant-philic liquid, the contaminant liquid is removed from the fiber surface and entrapped in the contaminant-philic liquid.

In its broadest scope, the present invention includes a process and apparatus for manufacturing a fiber-reinforced composite article; including a pre-treatment step and a pretreatment device for removing contaminants from the surface of a continuous fiber reinforcement. The fibers are typically stored in rolls (unidirectional fabric, woven fabrics, braided fabrics, etc.) or creels (fiber rovings); and the fibers are pulled from their stored state into a guiding frame. The guiding frame may either consolidate or keep separate the continuous reinforcement. The reinforcement is then drawn through a pretreatment apparatus adapted for removing at least a substantial portion, or substantially all, of a liquid or a solid contaminant present on the surface of the fibers through a process of convective heating. The pretreatment apparatus also referred to herein as the decontamination unit can be for example a heating unit for blowing heated air or gas through the decontamination unit for removing the contaminants from the fibers.

The speed of the continuous reinforcement throughput is such that there is sufficient residence time within the heating unit to remove the liquid or solid contaminant. Thereafter, the pretreated fibers are passed through a resin impregnation apparatus to contact and coat the fibers with a thermosetting polymer resin. The resin impregnation apparatus can include for example an open bath containing a thermosetting polymer resin. Then, the fibers, wetted with the thermosetting polymer resin and exiting the resin impregnation apparatus, are further processed using a filament winding manufacturing apparatus to form a shaped composite article, which in turn, is cured to form a cured fiber-reinforced composite article.

In a preferred embodiment, the present invention includes a process of manufacturing a void-free fiber-reinforced composite article; wherein such process includes the steps of:

(a) providing a continuous fiber reinforcement;

(b) providing an in-line device for removing contaminants from the continuous fiber reinforcement;

(c) pre-treating the continuous fiber reinforcement by passing the fiber reinforcement through the -line contaminant removal device of (b) and heating the continuous fiber reinforcement within the contaminant removal device;

(d) providing resin impregnation apparatus containing a thermosetting polymer resin;

(e) passing the pretreated continuous fiber reinforcement from the contaminant removal device of (b) through the resin impregnation apparatus of (d); the resin impregnation apparatus comprising an open-bath of a resin formulation containing a thermosetting polymer resin for impregnating the resin formulation containing a thermosetting polymer resin into the pretreated continuous fiber reinforcement; a resin injection means for impregnating a resin formulation containing a thermosetting polymer resin into the pretreated continuous fiber reinforcement; or a combination thereof;

(f) contacting the pretreated continuous fiber reinforcement from the pre-treatment step (c) with the thermosetting polymer resin contained in the resin impregnation apparatus by passing the pretreated fiber reinforcement through the resin impregnation apparatus;

(g) providing a filament winding manufacturing apparatus;

(h) passing the pretreated continuous fiber reinforcement from the resin impregnation apparatus through the filament winding manufacturing apparatus to form a shaped composite article; and

(i) curing, for example by thermal curing (heating), the shaped composite structure from the filament winding apparatus to form a cured void-free fiber reinforced composite article.

The fiber-reinforced composite article is prepared starting from a continuous fiber reinforcement; and then in-line pre-treating the continuous fiber reinforcement to remove contaminants such as moisture and/or solvent.

The continuous fiber reinforcement used in the present invention process can include, for example, one or more of carbon, glass, aramid (e.g., Kevlar®, Twaron®, and the like.), ceramic (e.g., silicon carbide, aluminum oxide, the like); and mixtures thereof.

In a preferred embodiment, the continuous fiber reinforcement useful in the process of the present invention may include for example, glass fibers (e.g., E-glass, S-glass, and the like.), and carbon fibers (e.g., polyacrylonitrile-based and pitch-based), and mixtures thereof.

The amount of continuous fiber reinforcement used in the present invention process may range generally from about 50 weight percent (wt %) to about 95 wt % in one embodiment, from about 60 wt % to about 90 wt % in another embodiment, and from about 65 wt % to about 85 wt % in still another embodiment, based on the weight of the composite structure.

In the environment in which the fiber reinforcement material is shipped and stored, depending on the humidity of the storage environment, some amount of moisture may collect on the surface of the fiber reinforcement material. Also, the fiber reinforcement material may contain solvents and/or other unwanted contaminants which are remnants of the manufacturing process of the fiber reinforcement material. Again, depending on the, manufacturing, shipping and storage of the fiber reinforcement material, solid contaminants such as dust, liquid contaminants, and other undesirable solid and/or liquid contaminants such as water or sizing agents can collect on the surface of the fiber reinforcement material.

Often, through some type of exposure unwanted liquids contaminate the surface of a continuous fiber reinforcement which is to be used in a filament winding process. One of the most problematic contaminants when handling polyurethane-based fiber reinforced composite materials is water or moisture collection on the surface of the fiber itself. Polyurethanes are known to be highly water sensitive to less than (<) about 300 ppm as disclosed in Shkapenko, G., Gmitter, G. T. and Gruber, E. E. Ind. Eng. Chem. 52, 7 605 (1960). One possible solution to remove moisture from the continuous fiber reinforcement is to pre-process the continuous fiber reinforcement to remove the moisture (such as a climate controlled room) but this pre-processing step is both time consuming and asset intensive. Additionally, water may collect on these materials even after the continuous fiber reinforcement is pre-processed. Therefore, the process of manufacturing a fiber-reinforced composite article using an in-line pre-treatment step using a pretreatment device to remove moisture is beneficial to making a composite product without a substantially high amount of contaminants such as water or moisture.

Typically, the fiber reinforcement material used in the present invention may contain an initial moisture content in an amount of generally from about 250 ppm to about 10,000 ppm in one embodiment, from about 350 ppm to about 5,000 ppm in another embodiment, and from about 400 ppm to about 3,500 ppm in still another embodiment. It is important to remove the above moisture content from the fibers to prevent a detrimental reaction between the moisture and the thermosetting resin during curing of the fiber/resin mixture.

In another embodiment, the fiber reinforcement material used in the present invention may contain solvent(s) in an initial amount of generally from about 250 ppm to about 10,000 ppm in one embodiment, from about 350 ppm to about 5,000 ppm in another embodiment, and from about 400 ppm to about 3,500 ppm in still another embodiment. It is important to remove the solvent(s) from the fibers to prevent a detrimental reaction between the solvent(s) and the thermosetting resin during curing of the fiber/resin mixture.

In one preferred embodiment, the continuous fiber reinforcement used in the present invention is passed through a pre-treatment device such that the fiber reinforcement undergoes a pre-treatment process to remove contaminants from the fiber reinforcement.

Preferably, the final moisture content or solvent content on the fiber reinforcement material of the present invention after being treated in the pre-treatment device is zero (0) but more generally the final moisture content or solvent content on the fiber reinforcement material may be from 0 to less than about 300 ppm in one embodiment, from 0 to less than about 250 ppm in another embodiment, from 0 to less than about 200 in still another embodiment, and from 0 to less than about 100 ppm. In other embodiments, the contaminant level of the final fiber reinforcement is from about 0.1 ppm to about 300 ppm in one embodiment, and from about 1 ppm to about 250 ppm in another embodiment.

In one embodiment, the pre-treatment process includes the following general steps: (1) passing fiber reinforcement material through the pre-treatment device; (2) heating the fiber being passed through the pre-treatment device with a heating fluid medium, such as a gas or liquid, to a temperature sufficient to evaporate the contaminant present on the fiber; and (3) then allowing the fiber exiting the pre-treatment device to cool to a temperature below the heating temperature of step (2), which is a temperature that does not prematurely activate a cross-linking reaction associated with thermosetting chemistry.

In general, the pre-treatment process for removing contaminants can be used for example to remove liquid contaminants such as moisture present on the surface of the fibers. Such process includes the steps of: (I) providing a fiber reinforcement material containing an initial amount of contaminant(s) such as moisture on the surface of the fiber reinforcement; and (II) heating the fiber reinforcement material at a temperature sufficient to form a pre-treated fiber reinforcement containing a moisture content of less than the initial moisture contaminant content before the fiber reinforcement is heated. For example, the moisture content of the final fiber reinforcement after heating may include a range as small as from 0 wt % to less than about 1 wt %.

The temperature of heating in step (I) can generally be in the range of from about 40° C. to about 500° C. in one embodiment, from about 60° C. to about 300° C. in another embodiment, and from about 80° C. to about 250° C. in still another embodiment. Depending on the process conditions in any specific application, a temperature that is lower than about 40° C., may not properly evaporate the liquid contaminant. Ideally, the heating temperature in step (I) should be as high as possible to facilitate contaminant removal, but, the temperature should not be so high that the fibers cannot return to their original temperature. This would cause a premature activation of the mixed fiber and thermosetting resin system upon contacting the fiber with the thermosetting resin.

The heating time in step (I) may be, for example, generally from about 100 milliseconds (ms) to about 100 seconds (s) in one embodiment, from about 500 ms to about 75 s in another embodiment, and from about 1 s to about 50 s in still another embodiment. The time that the fiber reinforcement spends at elevated temperature may be dictated by the manufacturing speed. Too long of a residence time in the pre-treatment device at elevated temperatures may result in needing more cooling of the fiber before the fiber enters the resin impregnation apparatus. Too short of a residence time at elevated temperatures may result in insufficient removal of the contaminants on the fiber.

The process of the present invention for pre-treating the fiber reinforcement may be a batch process, an intermittent process, or a continuous process using the pretreatment device of the present invention.

In an alternative embodiment, the pre-treatment process includes the following general steps: (1) passing fiber reinforcement material through the pre-treatment device; (2) contacting the fiber reinforcement material with a contaminant-philic solvent that: (a) is capable of sufficiently capturing and removing the contaminants on the surface of the fiber reinforcement material, (b) is not itself a contaminant, and (c) is adapted to not leave a contaminant on the surface of the fiber reinforcement material after the solvent contacts the fiber reinforcement material; and (3) removing the solvent and contaminant mixture from the surface of the fiber such that the solvent does not prematurely activate the cross-linking reaction associated with thermosetting chemistry upon the decontaminated fiber contacting the thermosetting resin.

In one preferred embodiment, the pre-treatment device for removing contaminants from the fiber reinforcement material may include for example, a vessel adapted for passing the fibers therethrough, for passing a heated fluid medium such as gas or liquid therethrough, and for contacting the fibers with the heated fluid medium. The vessel with heated fluid medium may be, for example, a closed or open tank, container, housing, chamber, or box, and the like. The heated fluid medium may be for example heated gas or heated liquid, and more preferably heated air.

For example, in a preferred embodiment, the pretreatment device comprising the vessel with heated fluid medium (e.g., heated air) for removing contaminants from a fiber reinforcement material may include:

(a) a closed heated vessel;

(b) an entry means for feeding a fiber reinforcement into the vessel (a);

(c) an exit means for discharging a fiber reinforcement from the vessel (a);

(d) a passageway in the heated vessel for allowing the fiber reinforcement from (b) to enter into the interior of the vessel (a) through the entry means, and for allowing the fiber reinforcement from (b) to exit the interior of the vessel (a) through the exit means;

(e) a heating element or unit for heating air;

(f) an entry means for feeding heated air into the vessel (a);

(g) a means for feeding heated air from (e) into the heating chamber of (a);

(h) an exit means for discharging heated air from the vessel (a); and

(i) a passageway in the vessel for allowing heated air to enter into the interior of the vessel (a) through the heated air entry means, and for allowing heated air to exit the interior of the vessel (a) through the heated air exit means.

In another preferred embodiment, the pre-treatment device for removing contaminants from the fiber reinforcement material may include for example, a vessel adapted, for containing a liquid solvent therein, for passing the fibers therethrough, and for contacting the fibers with the liquid solvent. The vessel for containing a liquid solvent, and more specifically a vessel containing a hydrophilic solvent, may be an open bath, tank, container, housing, chamber, or box.

For example, in one embodiment, the pretreatment device comprising the vessel for containing a liquid solvent for removing contaminants from a fiber reinforcement material may include:

(a) an open vessel adapted for containing a liquid solvent;

(b) an entry guiding means for feeding a fiber reinforcement into the vessel (a) and submerging the fibers in the liquid solvent;

(c) an exit guiding means for discharging the fiber reinforcement from the vessel (a) and out of the liquid solvent;

(d) a guiding means for allowing the fiber reinforcement to enter into the vessel (a) through the entry guiding means such that the fibers contact the liquid solvent, and for allowing the fiber reinforcement to exit the interior of the vessel (a) through the exit guiding means after the fibers contact the liquid solvent;

(e) a heating element for heating the liquid solvent;

(f) a means for evaporating the solvent from the fibers to form solvent free fibers exiting the vessel (a).

The pre-treated continuous fiber reinforcement prepared as described above is passed through an open resin bath containing a curable polymer resin formulation for coating/impregnating the fibers. The resin formulation used in the process of the present invention can be any thermosetting resin composition with the properties required for use in the in-line process. For example, in one embodiment, the formulation may include: (i) a thermosetting polymer resin, and (ii) a curing agent for curing the thermosetting polymer resin.

Typically, the thermosetting polymer resins useful in the present invention may include ester-based systems (polyesters and vinyl esters), phenolics (novolac and resole), polyurethanes (polyether and polyester-based), epoxies (liquid, novolac and solid) and mixtures thereof where it proves advantageous for such combinations.

In a preferred embodiment, the resin useful in the process of the present invention may include for example, one or more polyether-based polyols, one or more polyester-based polyols, and mixtures thereof.

Gum, W. F., Wolfram, R. and Ulrich, H. Reaction Polymers: Chemistry, Technology, Applications, Markets. Hanser Publishers (1992) discloses that polyester and vinyl ester resins are usually diluted with a reactive unsaturated monomer, such as styrene or methyl methacrylate, and reacts into the polymer matrix during the curing process. However, unsaturated volatile monomers such as styrene are causing increasing environmental, health and safety concerns. Therefore, a preferred embodiment of the resins used in the present invention process include resins that are free of volatile organic compounds without sacrificing mechanical, thermal and chemical properties in the final cured fiber-reinforced composite structure or article.

In another preferred embodiment, epoxy based resin systems or formulations are used in the present invention process because in general epoxy based resins are more acceptable based on environmental, health and safety aspects provided that the curative is selected with an end-use in mind. The epoxy resin systems can provide good initial viscosity pot life, gel times and mechanical properties. However, epoxy systems for filament winding are typically relatively unreactive at room temperature (about 25° C.) and require significantly heating to drive the cross-linking reaction between the epoxy and the curing agent. This un-reactivity at room temperature can lead to excessive dripping and waste during the processing of a composite part. Additionally, Ellis, B. Chemistry and Technology of Epoxy Resins. Spring Science and Business Media, B.V. (1993) discloses that epoxies exhibit a vitrification mechanism whereby the cross-linking reaction will slow or in some cases stop if not heated properly after winding. In addition, during curing of the epoxy resin matrix, internal stresses can develop in the curing epoxy and thus multi-step curing schedules are preferably used. For example, utilizing a methyltetrahydrophthalic anhydride (MTHPA) to cure a bisphenol-A-based epoxy can in some instances require two or even three steps in the bisphenol-A-based epoxy resin's curing profile (for example, 2 hours at 80° C.; 4 hours at 120° C.; and 4 hours at 150° C.) to reach maximum mechanical performance

Polyurethane-based systems or formulations for filament winding are also advantageous for a number of reasons including low volatile organic compound content and increased matrix toughness when compared with incumbent epoxy technology. Polyurethane-based chemistry can also be cured to full properties faster than epoxy-based chemistry. However, those skilled in the art are hesitant to adopt polyurethane-based chemistry for use in an open bath configuration of a filament winder due to polyurethane's reactivity with water. Sonnenschein, M. F. Polyurethanes: Science, Technology, Markets, and Trends. Wiley Series on Polymer Engineering and Technology. John Wiley & Sons, Inc. (2015) discloses that the reaction of an isocyanate group with water forms a carbamic acid intermediate that immediately decomposes to an amine and carbon dioxide. This carbon dioxide generation tends to lead to foaming within the curing polyurethane matrix. Bubbling within the laminate structure of the composite can act as localized stress concentrators that severely reduce the overall performance of a composite part and in most cases make the composite part un-usable. It is therefore advantageous to produce a polyurethane fiber reinforced composite without the presence of bubbling or foaming within the laminate structure.

One of the key properties of the thermosetting resin formulation of the present invention is its low viscosity (<about 1500 mPa-s) to facilitate fiber wet-out during the composite fabrication process. The thermosetting resin formulation of the present invention generally has a viscosity in the range of from about 100 mPa-s to about 1,400 mPa-s in one embodiment, from about 200 mPa-s to about 1,200 mPa-s in another embodiment, and from about 250 mPa-s to about 1,000 mPa-s in still another embodiment.

If the viscosity of the resin is too high (e.g., >about 1500 mPa-s), fiber impregnation becomes difficult due to the limited diffusion speeds of the resin into the fiber bundle. If the viscosity of the resin is too low (e.g., <about 100 mPa-s), the resin will drain out of the fiber bundle.

The concentration of the resin used in the present invention may range generally from about 10 wt % to about 90 wt % in one embodiment, from about 20 wt % to about 70 wt % in another embodiment, and from about 25 wt % to about 50 wt % in still another embodiment, based on the total weight of the entire composition (i.e., the weight of the resin and fiber).

The curing agent used to cure the thermosetting resin useful in the present invention may include, for example, known curing agents for vinyl esters, polyesters, phenolics, polyurethanes and epoxies; and mixtures thereof. Consideration to obtaining advantageous mechanical, thermal, electrical and the like properties is taken into account when selecting the curing agent.

In a preferred embodiment, the curing agent useful in the process of the present invention may include for example, one or more isomers of toluene diisocyanate (TDI), one or more isomers of monomeric methylene diphenyl diisocyanates (MDI) as well as polymeric methylene diphenyl diisocyanates, one or more aliphatic isocyanates (hexamethylene diisocyanate, isophorone diisocyanate and the like), and mixtures thereof.

The curable thermosetting polymer resin/curing agent composition useful in the present invention may include other optional additives such as one or more catalysts (tertiary amine, alcohol amine and the like), one or more chain extenders (ethylene glycol, 1,4-butane diol and the like), one or more cross-linking promoters (glycerine, triethanolamine and the like), one or more plasticizers (phthalate esters, ethyl phosphates and the like), one or more adhesion promoters (amino silanes and the like) and one or more thixotrope agents for flow control (fumed silica and the like); and mixtures thereof.

In one embodiment, the resin formulation in the open bath which is applied to the fiber reinforcement by submerging the fibers in the resin bath, beneficially has a viscosity sufficient to impregnate the fiber reinforcement but has a viscosity insufficient to allow dripping of the resin as the resin impregnated fiber reinforcement exits the resin bath. For example, the viscosity of the overall resin formulation generally may be from about 100 mPa-s to about 1500 mPa-s in one embodiment, from about 150 mPa-s to about 800 mPa-s in another embodiment, and from about 200 mPa-s to about 600 mPa-s in still another embodiment. If the viscosity of the thermosetting polymer system in the open resin bath is too high, it is difficult for the thermosetting liquid to penetrate the fiber bundle resulting in a cured composite article with dry fibers. This decreases the performance of the composite article. Conversely, if the viscosity of the thermosetting polymer system is too low, upon the application of the liquid and subsequent winding of the liquid covered fiber bundle, the liquid will drip out of the fiber bundle. This will result in portions of the cured composite article having dry fibers resulting in decreased performance of the composite article.

An alternative process for impregnating fibers that have been decontaminated may include the use of a resin injection device instead of an open resin bath. For example, in a filament winding process a closed fiber impregnation device (also referred to as fiber infusion device or fiber injection device) can be used. Continuous fibers are pulled through the impregnation device using a pulling means to pull the fibers through a filament winding process.

Generally, the process and apparatus for impregnating a fiber reinforcement material such as a continuous filament using the impregnation device includes:
(a) introducing dry fiber tows into the injection device, wherein the fiber tows preferably have a constant cross-section; (b) introducing a thermosetting polymer resin composition into the injection device; (c) contacting the polymer resin composition with the dry fiber tows inside the injection device; (d) metering the resin composition into the injection device sufficient for the resin to coat and impregnate the dry fiber tows and for a sufficient time to wet the fibers inside the injection device to form wetted fibers; (e) withdrawing wetted fiber tows impregnated with the thermosetting polymer resin composition from the injection device.

The thermosetting polymer resin composition used to impregnate the fiber reinforcement material is essential a curable reaction mixture that cures upon heating to a predetermined temperature or upon subjecting to ultraviolet light curing. The fibers are contacted with the curable thermosetting polymer resin composition inside the impregnation device for a time period and at a temperature sufficient to cause substantial impregnation of resin in the fibers and such that partial polymerization of the resin occurs to form a rigid article for further processing. The composite of coated fibers are passed through a heated curing apparatus to at least partially advance the cure of the reaction mixture so as to produce a solid fiber reinforced polymer matrix. The solid composite is drawn from the curing means and then fully or completely cured, for example, at a curing time of form about 15 minutes (min) to about 100 min at a temperature of from about 35° C. to about 150° C.

From the open bath containing a resin formulation, a filament winding process (or other known composite forming processes such as pultrusion, resin transfer molding, or mixtures thereof) can be used to form a composite structure. The composite structure can be for example a cylindrical structure or pipe. In a preferred embodiment, a composite structure is manufactured using a filament winding process.

Filament winding is one of the more important composite production methods in terms of number of users and total number of fabricated parts. The filament winding process begins with fiber tows coming from spools of glass or carbon fibers mounted on a creel. The fibers are gathered together and collected through a type of fiber guide (i.e., a “comb”) to form a band. The number of the fibers brought together determines the band width. The band is pulled through a resin bath (containing a resin and a hardener mixed together such that the system is active). The resin from the resin bath impregnates the pulled fiber tow. The fibers are then drawn through a roller or wiper system to achieve the desired resin content on the fibers; and then the fibers are drawn through a payoff. The “payoff” is the point at which the fiber contacts a moving carriage and directs the fibers on to a rotating mandrel. This method of production is efficient for producing any type of cylindrical part. Furthermore, as the complexity and capability of filament winding machines increases other non-cylindrical parts can also be wound using a filament winding method.

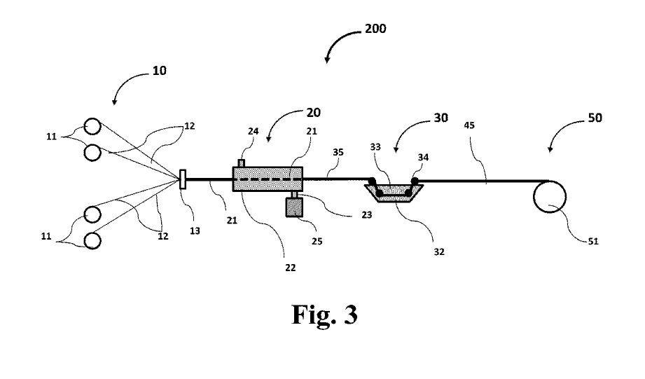

With reference to FIG. 3, there is shown a schematic process flow chart of the equipment and process for dispensing of continuous fiber into a filament winding process, The filament winding apparatus, generally indicated by numeral 200 includes a fiber reinforcement feeding apparatus, generally indicated by numeral 10; a pretreatment device of the present invention, generally indicated by numeral 20; a resin coating means, generally indicated by numeral 30; and a filament winding apparatus, generally indicated by numeral 50; all which are connected in flowing alignment with each other.

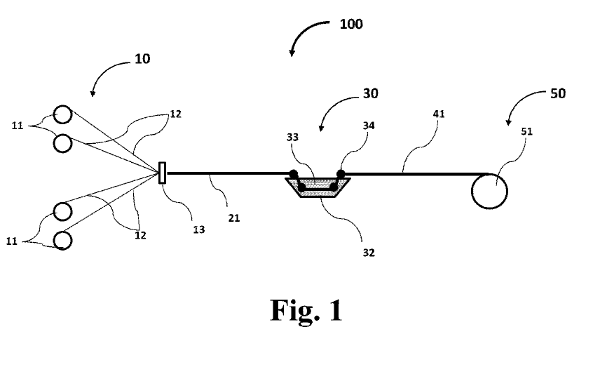

The apparatus and process of the present invention 200 is similar to FIG. 1, wherein the process/apparatus 200 includes a fiber reinforcement feeding apparatus 10 which may include stored continuous spools or creels 11 of fibers 12 for dispensing the several continuous fibers 12 to the process. Again with reference to FIG. 3, there is shown a first and a second set of stored continuous fibers on spools 11 with continuous fibers12 on the spools. The continuous fibers 12 from spools 11 are dispensed into the process by first passing through a guide bar for filament alignment such as a guiding comb 13. The fibers 12 are consolidated and passed through guide bars or a guiding unit 13 for filament alignment and forming a consolidated fiber reinforcement 21. The fibers 21 exiting from the guide 13 are passed through the pretreatment heating unit 20 of the present invention.

The pretreatment device 20 is an in-line heating unit with a single consolidated fiber bundle 21 passing to the housing 22. The pretreatment unit 20 may include for example at least: (i) a heating unit body or housing 22, (ii) a heating unit housing hot air entrance 23, and (iii) a heating unit housing hot air exit 24. The hot air passing through the housing 22 is heated using a heater or heating device 25. The consolidated fiber tows 21, entering the heating zone of the pretreatment heating unit 20 are consolidated fiber reinforcement containing contaminants, i.e., the consolidated fiber reinforcement 21 contains contaminants. The consolidated fiber reinforcement 21 with contaminants is fed to the pre-treating means or device 20 which includes a heating zone inside the housing unit 22. The contaminated fibers 21 undergo a pretreatment contaminant removal process as the fibers 21 pass through the heating zone of the pretreatment device 20 and exit the heated pretreatment device 20 as treated fibers 35 i.e., consolidated fiber reinforcement with removed contaminant As the contaminated consolidated bundle 21 passes through the pretreatment device 20, the bundle of fibers 21 is heated in the pretreatment device 20 by passing hot convective air through the pretreatment device housing 22. The hot air is provided by a heating device 25 and enters the pretreatment device housing 22 through an inlet 23 on the side wall of the pretreatment device housing 22. Subsequently, air leaves the heated pretreatment device housing 22 through an outlet 24 on the opposite side wall of the pretreatment device housing 22. The residence time in the pretreatment device housing 22 is controlled by the fiber drawing speed and is chosen such that the fiber bundle has enough time in the pretreatment device housing 22 to remove the contaminant of interest to below an acceptable level.

After the fibers 12 are drawn through fiber guides 13 to consolidate the fibers 12 into a single bundle of contaminated fibers 21 and the fibers 21 are pre-treated in the pretreatment device 20, the pre-treated fibers leave the pretreatment unit 20 as fibers 35. The treated fibers 35 are then sent to the resin bath 30, i.e., the uncontaminated continuous fiber bundle 35 leaves the pretreatment device housing 22 and is drawn into the fiber immersion bath means 30. The pretreated fibers 35 enter the open bath 32 containing thermosetting resin 33 wherein the fiber bundle 35 is impregnated with the thermosetting polymer formulation 33 and then the impregnated fibers pass through directional fiber guides 34 to exit the bath 32 as treated uncontaminated fibers 45. The impregnated fibers 45 leaving the open bath 32 are then sent to a filament winding apparatus 50.

The consolidated impregnated fiber reinforcement fibers 45 containing uncured or partially cured thermosetting liquid thereon are pulled from the open bath 32; and the impregnated fibers 45 leaving the open bath 32 are drawn onto a rotating mandrel 51 of the filament winding apparatus 50 to form a composite article, for example, a pipe member. The mandrel 51 is to build up a composite overwrap of fibers 45. The final composite overwrap (i.e., the final wound composite part on the mandrel) such as a pipe member is typically cured through an elevated temperature post-winding curing step with a curing means or mechanism such as a post-heating curing apparatus (not shown). The use of the in-line contaminant removal process and apparatus 200 significantly reduces carbon dioxide formation in the interlaminar structure of the final composite. Once cured, the pipe member product coming off the mandrel 51 can be cut to a desired predetermined length.

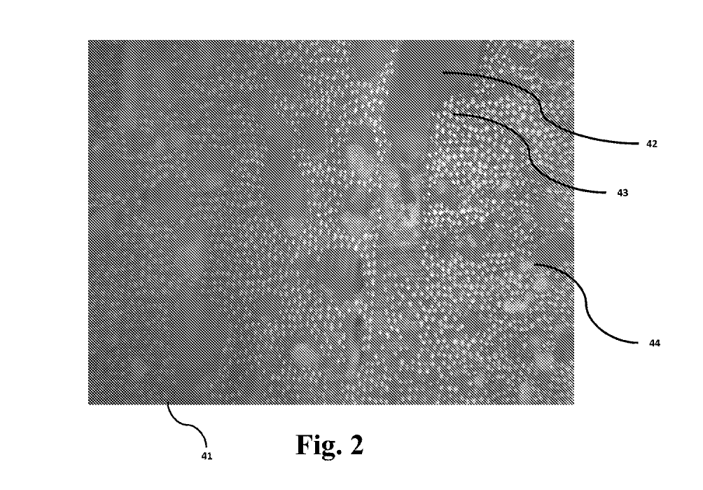

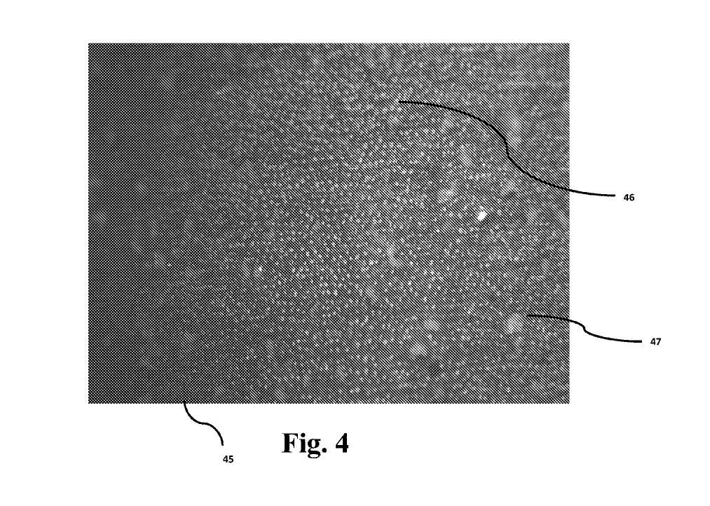

With reference to FIG. 4, there is shown a micrograph image (at 10× magnification) of a cross-sectional view of a composite structure made with polyurethane based-chemistry and the filament winding process of FIG. 3. The image in FIG. 4 is of a cross-sectional view of a composite structure prepared by the process described above with an in-line pretreatment heating unit 20 as compared to the micrograph image (at 10× magnification) shown in FIG. 2 of a cross-sectional view of a composite structure prepared by the process described above without an in-line pretreatment heating unit 20. For example, FIG. 4 shows a micrograph image (at 10× magnification) of the fiber reinforcement 45 which includes glass fiber 46; and Zeolite water scavenger 47, but does not include voids 42 caused by bubbling foaming as shown in FIG. 2. The micrograph image of FIG. 2 shows air formation in the composite structure and voids caused by bubbling foaming when preparing the composite structure. A large amount of void space can be readily observed in the resulting composite. This is due to the water-contaminant on the surface of the fibers reacting with the isocyanate curing agent in the formulation. The image in FIG. 4, on the other hand, shows no voids formed in the composite structure or at least a reduced amount of voids because any water-contaminant on the surface of the fibers was removed.

Based on the results of the micrograph images in FIG. 2 and FIG. 4, if a fiber reinforcement material is not pretreated to remove any contaminants on the surface of the fibers, for example contaminants such as moisture, the resulting cured fiber-reinforced composite article will contain undesirable voids which can lead to a non-homogenous composite structure. The voids within the structure act as stress concentrators when the composite structure is deformed through different means. In FIG. 4, the composite contains no air formation in the composite structure. The small particles shown in the image of FIG. 4 are water scavengers that do not detrimentally affect the performance of the composite.

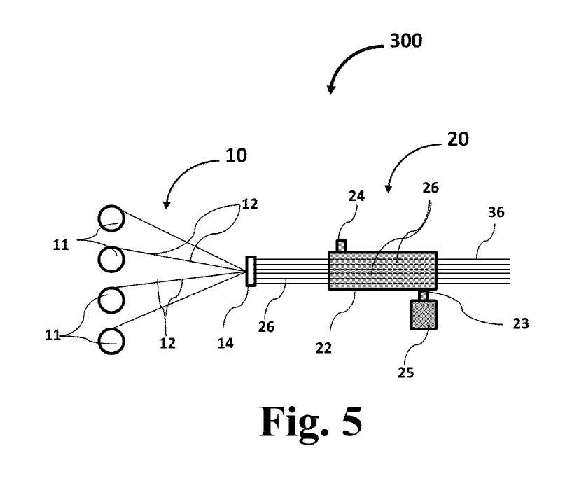

With reference to FIG. 5, there is shown a partial schematic flow diagram showing another embodiment implementing an in-line contaminant removal pretreatment device, generally indicated by numeral 300, using a filament winding process. As opposed to FIG. 3 described above which shows an in-line heating unit with a single consolidated fiber bundle passing through the pretreatment means 20, FIG. 5 shows the front end portion of an in-line heating pretreatment apparatus 20 with multiple fiber tows 26 passing through the heated housing 22 of the pretreatment device 20 forming pretreated fibers 36.

With reference to FIG. 5 again, there is shown an alternate setup of the in-line contaminant removal device 20 where the fibers 26 fed to the housing 22 are not consolidated into a single bundle as in FIG. 3, but instead the fibers 26 are separate fibers that remain separated as the fibers 26 are passed through the housing 22 for pretreatment. The pretreatment of the separate fibers 26 accelerates the contaminant removal process. The fiber feeding means 10 is the same as shown in FIG. 3 except that the fibers 12 stored in creels 12 are drawn through fiber guides 14 to form separated fibers 26 and to keep the fibers 26 separated as the fibers are fed into the heated housing 22. The contaminated separated bundle drawn through the housing 22 are heated through convective air. The hot air is provided by a heating device 25 and enters through an inlet 23 on one side of the housing 22. Subsequently, the hot air after contacting the fibers 26 leaves the heated housing 22 through an outlet 24 on the opposite side of the housing 22. The residence time in the housing is controlled by the fiber drawing speed and is chosen such that the separated fibers have enough time in the housing to remove the contaminant of interest to below an acceptable level (e.g., less than about 100 ppm). The uncontaminated or decontaminated continuous fibers leave the housing 22 as pretreated fibers 36 and continue on to the composite fabrication process (not shown, however, this part of the process is similar to FIG. 3).

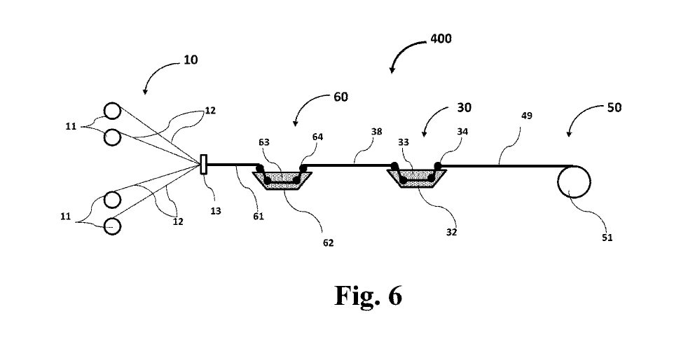

FIG. 6 is a schematic flow diagram showing still another embodiment of a filament winding process, generally indicated by numeral 400, of the present invention including a pretreatment device 60 of the present invention. The schematic flow diagram of FIG. 6 shows an alternative pretreatment device, generally indicated by numeral 60, of the present invention comprising an open bath 62 containing a contaminant-philic liquid 63 for removing contaminants on the surface of a fiber bundle 61 passing therethrough, an open bath 32 containing thermosetting liquid 33, and a rotating mandrel 51 for forming a composite article.

With reference to FIG. 6 again, there is shown a fiber feeding means, generally indicated by numeral 10 which includes fibers 12 stored in creels 11. The fibers 12 are drawn and consolidated into a single bundle through fiber guides 13 to form contaminated consolidated bundle 61. The contaminated consolidated bundle 61 is then drawn through a pretreatment bath (washing bath) 62 that is filled with a contaminant-philic liquid appropriately selected and adapted for removing a predetermined specific contaminant

The residence time in the washing bath 62 is controlled by the fiber drawing speed and is selected such that the fiber bundle 61 has enough residence time in the bath 62 to remove the contaminant of interest to below an acceptable level such as less than about 100 ppm to form an decontaminated or pure fiber 38 leaving the bath 62. The uncontaminated continuous fiber bundle 38 leaves the washing bath 62 and the fibers 38 are given enough open residence time for the contaminant-philic liquid to flash off at room temperature (about 22-25° C.) as the bundle 38 moves to the next process step. The fiber bundle 38 is then drawn into a fiber immersion bath 30 where the fiber bundle 38 is impregnated with a thermosetting polymer composition 33 contained in the bath 32, and the impregnated fibers 49 leave the bath 32 by passing through guides 34 and are drawn onto a rotating mandrel 51 to build up a composite overwrap. The final wound composite part is typically cured through an elevated temperature post-winding step. A micrograph image of a cross-section of a composite structure prepared by the above process contains a void-free structure similar to the image shown in FIG. 4.

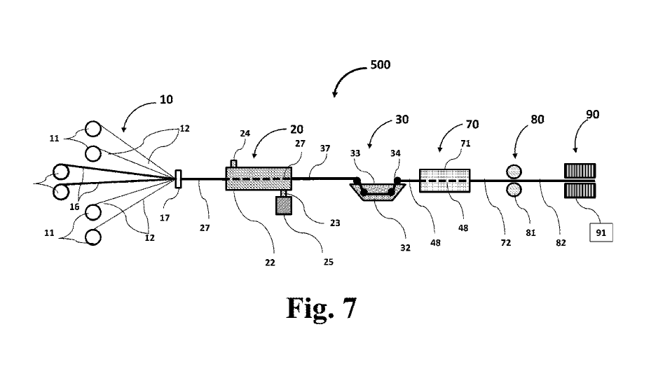

FIG. 7 is a schematic flow diagram showing another embodiment of a filament winding process, generally indicated by numeral 500, of the present invention including a pretreatment device 20 of the present invention. The pretreatment device 20 is similar to the pretreatment device in FIG. 3 which includes an in-line heating unit 20 with a single consolidated fiber bundle 27 passing therethrough. The schematic flow diagram of FIG. 7 shows an open bath 30 containing thermosetting liquid, a curing die generally indicated by numeral 70, a pulling apparatus generally indicated by numeral 80 and a cutting apparatus generally indicated by numeral 90 for cutting a cured fiber reinforcement composite article fabricated by the process and apparatus of the present invention.

With reference to 7 again, there is shown a first set of fibers 12 stored on a first set of creels 11 and a second set of fibers 16 stored on a second set of creels 15. The combination of fibers 12 and 15 are drawn and consolidated into a single bundle of fibers 27 through fiber guides 17. Additionally, optional woven or stitched material (not shown) can be drawn into the composite fiber bundle structure and consolidated at the fiber guides 17 to form fibers 27. The contaminated consolidated bundle 27 is drawn through the housing 22 of the pretreatment device 20 and heated using convective air passing through the housing 22. The hot air is provided by a heating device 25. The hot air enters the housing 22 through an inlet 23 on one side of the heated housing 22. Subsequently, the hot air, after contacting the fibers 27, leaves the heated housing 22 through an outlet 24 disposed on the opposite side of the housing 22. The residence time of the fibers 27 in the housing 22 is controlled by the fiber drawing speed and the drawing speed is selected such that the fiber bundle 27 has enough time in the housing 22 to remove the contaminant on the fibers to below an acceptable level such as less than about 100 ppm. The uncontaminated continuous fiber bundle 37 leaves the housing 22 and is drawn into a fiber immersion bath 30 including an open bath 32 containing a thermosetting resin 33. The fiber bundle 37 is impregnated with a thermosetting polymer resin composition 33 in the bath 32. The bath 30 contains directional fiber guides 34 through which the fibers 37 are drawn to form an impregnated fibers 48. The impregnated fibers 48 are then drawn through a curing die 71 of shape forming apparatus, generally indicated by numeral 70, which cures and forms a composite article 72 of a predetermined shape such as a laminate structure or complex shaped structure composite. The thermosetting polymer resin on the fibers 48 undergoes a cross-linking reaction to form the cured composite 72. The cured composite 72 is pulled through the entire process with a pulling apparatus (or another apparatus that causes constant pull force), generally indicated by numeral 80, such as roller 81 for pulling the cured composite 72. The pulled cured composite 82 from the pulling apparatus 80 is then fed into a cutting apparatus, generally indicated by numeral 90 which includes, for example, a cutting device 91 for cutting the composite article to a desired predetermined length and/or size (not shown).

The composite product or article, such as pipe, prepared by the process of the present invention exhibits unexpected and unique properties. Using the contaminant removal pretreatment device and process, and the resin formulation of the present invention, a void-free composite article can be manufactured via an open-bath filament winding process.

For example, the composite of the present invention exhibits a void content generally between 0 percent (%) and about 9% in one embodiment, between about 0.05% and 7% in another embodiment, and between about 0.1% and 5% in still another embodiment.

Typical polyurethane formulations for filament winding, known in the prior art, have higher void content leading to a reduction in mechanical performance of the overall laminate structure formed from polyurethane formulations. In the present invention, limiting the void content ensures predicted performance of the composite article.

Some non-limiting examples of processes in which the pretreatment device for removing contaminants from a fiber reinforcement material of present invention can be used, may include, for example, a conventional open-bath filament winding process, a pultrusion process, a continuous pre-preg manufacturing process, a sheet molding compound manufacturing process, a thermoplastic composite compounding process, and mixtures thereof.

Enduses include making pipes, piping, or cylindrical members (pressure vessels and the like), parts of constant cross-section produced through traditional pultrusion (window lineals and the like), and parts of non-constant cross-section produced through any automated tape laying process using the process and apparatus of the present invention.

### EXAMPLES

The following examples and comparative examples further illustrate the present invention in more detail but are not to be construed to limit the scope thereof.

In the following Examples, various materials, terms and designations are used and are explained as follows:

“Advantex Glass Fiber”, “glass fiber” and the like is the commercial product Advantex Glass Fiber, Type-30, 366-AB-450, 1100 TEX available from Owens Corning.

“Wet mass” refers to the mass of a fiber sample that is not pretreated with heat or solvent.

“Fiber roving” refers to a single continuous strand of fiber that is comprised of a number of filaments. The number of filaments can range from a few hundred individual strands to many thousands.

“Fiber bundle” refers to the bundle of fiber that is formed from taking a number of individual fiber rovings and combining the individual fiber rovings to form a single large bundle of continuous fiber.

“Curable formulation”, “curable polymer” and the like refers to any thermosetting polymer system that is adapted to being cured and forming a cured network. The curable formulation includes formulations appropriate for the processes used in the examples. The composition of the curable formulation or polymer is described above.

Standard measurements, analytical equipment and methods were used in the Examples as follow:

Viscosity Measurements

The viscosity of the resin was measured according to the procedure described in ASTM D445 (2015).

Moisture Content on Fiber

The moisture content within the continuous fiber was measured by taking a specified length of fiber and weighing the fiber using a microbalance (balance with at least four significant figures) yielding a “wet mass”. The fiber was then placed in a convection oven for 12 hours (hr) and mass measurements were performed at increments of 1 hr. The change in mass of the length of fiber was compared to the undried fiber to calculate the moisture content of the fiber.

### Example 1

### Void-Free Polyurethane-Based Filament Winding Using Hot Air as the Contaminant Removal Mechanism

Using the apparatus and process illustrated in FIG. 3, a number of spools of continuous glass fibers (Advantex Glass Fiber, Type-30, 366-AB-450, 1100 TEX) were processed using a filament winding apparatus including a pretreatment device to remove moisture from the glass fibers. Before entering the pretreatment device, the fibers are drawn through a guide to form a single bundle of fibers (15 millimeters [mm]×2 mm in size). The fiber bundle entered the pretreatment device and hot air heated at 300° C. was passed through the pretreatment device to contact the bundle of glass fibers. The residence time of the glass fiber bundle in the pretreatment device was 3 s. The drawing speed of the fibers was 15 meters per minute (m/min). The cleaned (i.e., the moisture-free or decontaminated) glass fibers exited the pretreatment device and then fed to an open bath containing the following curable formulation: a polyether-based polyol mixed with a polymeric MDI. The fibers were wound onto a rotating mandrel to form a composite article (3 m×0.75 m in size).

The glass fibers containing the curable formulation were then cured at 100° C. for 2 hr to fully react the cross-linking polymer.

A horizontal cut perpendicular to the elongated longitudinal length of the cured composite was made to the composite to obtain a specimen showing the cross-sectional area of the composite for analysis. Shown in FIG. 4 is a micrograph image (at 10× magnification) taken of a cross-sectional view of the composite structure prepared by the process with an in-line heating unit, i.e., using an in-line contaminant removal process.

FIG. 4 shows a composite structure containing less air formation in the composite structure; and it was observed that the resulting composite structure contained no voids caused by bubbling foaming from an isocyanate and water reaction.

### Comparative Example A

### Polyurethane-Based Filament Winding Without Using Hot Air as the Removal Mechanism

This Comparative Example A was carried out similar to Example 1 above except that no pretreatment device was used. A number of spools of continuous glass fiber (Advantex Glass Fiber, Type-30, 366-AB-450, 1100 TEX obtained from Owens Corning) were processed using a filament winding device. The apparatus and process used in this example is illustrated in FIG. 1. The fibers are drawn through a guide to form a single bundle of fibers (15 mm×2 mm in size). The drawing speed of the fibers was 15 m/min. The fibers were fed to an open bath containing the following formulation: a polyether-based polyol mixed with a polymeric MDI. The fibers were wound onto a rotating mandrel to form a composite article (3 m×0.75 m in size). The glass fibers containing the curable formulation were then cured at 100° C. for 2 hr to fully react the crosslinking polymer.

A horizontal cut perpendicular to the elongated longitudinal length of the cured composite was made to the composite to obtain a specimen showing the cross-sectional area of the composite for analysis. Shown in FIG. 2 is a micrograph image (at 10× magnification) taken of a cross-sectional view of the composite structure prepared by the process without using an in-line contaminant removal device as in Example 1.

FIG. 2 shows a composite structure containing air pockets formation in the composite structure; and it was observed that the resulting composite structure contained about 25% by volume of voids caused by bubbling foaming from an isocyanate and water reaction.

### Example 2

### Void-Free Polyurethane-Based Filament Winding Using Solvent as the Contaminant Removal Mechanism

A number of spools of continuous glass fiber are processed using a filament winding apparatus. Before entering the pretreatment bath, the fibers are drawn through a guide to from a single bundle of fibers. The fiber bundle enters the pretreatment bath that contains a contaminant-philic liquid. The residence time of the glass fiber bundle in the pretreatment bath is such that the liquid is capable of removing the contaminant on the surface of the glass fiber. The cleaned (i.e., the moisture-free or decontaminated) glass fiber bundle exits the pretreatment bath and then is fed to an open bath containing a thermosetting polymer mixture that is sensitive to contaminants The fiber bundle is wound onto a rotating mandrel to form a composite article. The glass fiber bundle containing the curable formulation is then cured at a temperature that drives the cross-linking reaction to completion.

### Example 3

### Void-Free Epoxy Pultrusion Using an Open Bath Configuration

A number of glass fiber mats (stitched, woven or braided or a combination thereof) are processed using an open-bath pultrusion process including a pretreatment device to remove moisture from the glass fibers. Before entering the pretreatment device, the fiber mats and rovings are drawn through a guide to form a single bundle of glass fiber. The bundle of glass fiber is passed through the pretreatment device at a speed such that the residence time in the pretreatment device allows for the removal of all contaminant from the surface of the fibers. The cleaned (i.e., the moisture-free or decontaminated) glass fibers exit the pretreatment device and then are fed to an open bath containing a thermosetting polymer mixture that is sensitive to contaminants. The glass fiber bundle is then fed into a curing die where the fibers are at a sufficient temperature and are present in the die for a sufficient residence time to initiate and complete the cross-linking reaction of the curable polymer composition. The cured composite article is then pulled from the curing die and sectioned accordingly.

### Example 4

### Void-Free Epoxy Pultrusion Using Non-Consolidated Fiber Bundles

A number of glass fiber mats (stitched, woven or braided or a combination thereof) are processed using an open-bath pultrusion process including a pretreatment device to remove moisture from the glass fibers. In this process the fiber mats and rovings are kept separate as the fiber mats and rovings are passed into the pretreatment device. The separated glass fiber is passed through the pretreatment device at a speed such that the residence time in the pretreatment device allows for the removal of contaminants from the surface of the fibers. Keeping the mats and fibers separate allows for a lower residence time of the glass fibers in the pretreatment device due to the smaller depth of penetration required by the heat into the mat or fiber bundle. The cleaned (i.e., the moisture-free or decontaminated) glass fibers exit the pretreatment device and are then fed to an open bath containing a thermosetting polymer mixture that is sensitive to contaminants The glass fiber bundle is then fed into a curing die where the fiber bundle is at a sufficient temperature and is present in the die for a sufficient residence time to initiate and complete the cross-linking reaction of the curable polymer composition. The cured composite article is then pulled from the curing die and sectioned accordingly.

1. A process for removing contaminants from a fiber reinforcement material, the process comprising:
(a) feeding a fiber reinforcement into a heated vessel; wherein the heated vessel has a passageway for allowing the fiber reinforcement to enter into and pass through the heated vessel;
(b) passing the fiber reinforcement through the heated vessel; wherein the heated vessel has an exit means for allowing the fiber reinforcement from (a) to exit the heated vessel;
(c) heating a source of fluid medium;
(d) feeding the heated fluid medium from (c) into the heated vessel having a passageway in the heated vessel for allowing the heated fluid medium from (c) to enter into the heated vessel;
(e) passing the heated fluid medium through the heated vessel; wherein the heated vessel has a passageway for allowing the heated fluid medium from (c) to exit the heated vessel; and
(f) contacting the fiber reinforcement passing through the heated vessel with the heated fluid medium passing through the heated vessel such that any contaminants present in or on the fiber reinforcement is sufficiently reduced to provide a purified fiber reinforcement exiting the heated vessel.

2. The process of claim 1, wherein the contaminants present in or on the fiber reinforcement are reduced to less than about 250 parts per million.

3. The process of claim 1, wherein the fluid medium is air.

4. The process of claim 1, wherein the heat vessel is included in an in-line apparatus for removing contaminants from a continuous fiber reinforcement.

5. A process of manufacturing a void-free composite article, the process comprising:
performing the process for removing contaminants from the fiber reinforcement material as claimed in claim 1, and
producing the void-free composite article using a composite fabrication method selected from a filament winding method, a pultrusion method, an infusion method, a reaction injection molding method, or a pre-impregnation process.

6. A process of manufacturing a void-free composite article, the process comprising:
(a) performing the process for removing contaminants from the fiber reinforcement material as claimed in claim 1;
(b) providing a filament winding manufacturing apparatus;
(c) providing an open-bath resin containing a thermosetting polymer resin;
(e) passing the fiber reinforcement material from (a) through the open-bath;
(f) passing the fiber reinforcement material from (a) through the filament winding manufacturing apparatus to form a composite structure; and
(h) heating the composite structure to form a cured void-free fiber reinforced composite article.

7. The process of claim 6, wherein the in-line contaminant removal apparatus is a convective heat or cooling or a conductive heating or cooling device.

8. The process of claim 6, wherein the thermosetting polymer matrix resin is an epoxy-based resin, a polyurethane-based resin, a polyester-based resin, a vinyl ester-based resin, a phenolic-based resin, or a mixture thereof.

9. The process of claim 6, wherein the fiber reinforcement is glass, carbon, aramid, and mixtures thereof.

10. The process of claim 6, wherein the open-bath resin is selected from a submersion-type bath, a roller-type bath, or a combination thereof.

11. An apparatus for performing the process for removing contaminants from a fiber reinforcement material of claim 1, the apparatus comprising:
an in-line apparatus for removing contaminants from a continuous fiber reinforcement; said in-line apparatus comprising the heated vessel, wherein the heat vessel includes (a) a housing; (b) a means for feeding the fiber reinforcement into the heated vessel; (c) a first passageway in the heated vessel for allowing the fiber reinforcement from (b) to enter into an interior of the heated vessel; (d) a passageway in the heated vessel for allowing the fiber reinforcement from (b) to exit the heated vessel; (e) a heating device for heating the source of fluid medium; (f) a means for feeding the heated fluid medium from (e) into the interior of the heated vessel; (g) a passageway in the heated vessel for allowing the heated fluid medium from (e) to enter into the interior of the heated vessel of (a); and (h) a passageway in the heated vessel for allowing the heated fluid medium from (e) to exit the heated vessel of (a);
a means for passing a fiber reinforcement through the heated vessel to form a purified fiber reinforcement;
a resin infusion means for impregnating the purified fiber reinforcement with a thermosetting resin polymer composition to form an impregnated fiber reinforcement;
a means for passing the impregnated fiber reinforcement to a filament winding mandrel to form a wound impregnated fiber reinforcement; and
a means for heating the wound impregnated fiber reinforcement to form a void-free composite article.
